(19) United States
(12) Patent Application Publication
(10) Pub. No.: US 2025/0178727 A1
(43) Pub. Date: Jun. 5, 2025

(54) FLIGHT SYSTEM COMPRISING PIVOTABLE PROPULSION MODULES

(71) Applicant: Taig KHRIS, PARIS (FR)

(72) Inventor: Taig KHRIS, PARIS (FR)

(21) Appl. No.: 18/968,636

(22) Filed: Dec. 4, 2024

(30) Foreign Application Priority Data
Dec. 4, 2023 (FR) 2313497

(51) Int. Cl. B64C 39/02

(52) U.S. Cl. CPC B64C 39/026

(57) ABSTRACT

The present invention relates to a flight system comprising:
a harness configured to be worn by a user, said harness at least partially covering the torso and surrounding the hips of the user;
a plurality of primary propulsion modules connected to the harness, the plurality of primary modules being symmetrically distributed at the hips of the user, the primary modules being configured to exert a primary thrust force so as to raise or maintain the user in the air;
at least one energy reservoir configured to supply energy to the plurality of propulsion modules;
   the flight system being characterized in that the plurality of primary propulsion modules is pivotable at least between a vertical flight configuration and a horizontal flight configuration.

### TECHNICAL FIELD

The present invention relates to the technical field of flight systems.

More particularly, the present invention concerns the technical field of individual flight systems, in particular an individual flight system of the “Jet Pack” type.

### BACKGROUND

It is known from the state of the art of an individual flight system comprising at least one propulsion module configured to exert a thrust force for raising or holding a user equipped with the flight system. Such a flight system generally comprises a harness configured to be worn by the user like a backpack, with the propulsion module located on the user's back. The flight system is then commonly referred to as a “Jet Pack” type.

A “Jet Pack” type flight system with additional propulsion modules is known from the state of the art. For example, a flight system is described wherein said additional propulsion modules are attached to the user's arms, legs and plexus. The user can then fly in a flight configuration known as “vertical flight”, wherein a frontal plane of the user's body extends substantially perpendicular to the ground. Such a flight system has the advantage, for a given amount of on-board energy, of being able to distribute a plurality of thrust forces over the user's entire body, making it easier to stabilize the user in the air. Document GB2570773A describes a similar device, with an additional propulsion module attached to the user's lower back.

By way of example, another “vertical flight” embodiment is described in document US2018208312A1, wherein a platform equipped with a propulsion module is attached to the user's feet by means of boots occupying the harness function previously described.

Alternatively, document U.S. Pat. No. 10,364,028B1 describes a flight system wherein said propulsion modules are attached only to the arms, legs and sides of the trunk of a user equipped with the flight system. The user can then fly in a flight configuration known as “horizontal flight”, wherein the frontal plane of the user's body extends substantially parallel to the ground. Such a flight system also has the advantage of being able to distribute a plurality of thrust forces over the user's entire body, making it easier to stabilize the user in the air.

Nevertheless, existing flight systems have the disadvantage of forcing the user to maintain a substantially identical posture throughout the flight, that is, the orientation of the frontal plane of the user's body is substantially invariant during the flight. In addition, a user flying in a vertical or horizontal flight configuration must take off and land in the same vertical or horizontal flight configuration. In addition, flying in an intermediate configuration is also forbidden. Furthermore, in these systems, the user's limbs, that is, their arms and/or legs, are mobilized by the propulsion system, limiting the user's freedom of movement. Lastly, in existing flight systems, the user's stability and balance in flight are managed by the user alone, depending on his proprioceptive ability and mastery of the flight system, which can put him at risk of falling, particularly in the case of a novice user.

The invention therefore aims to solve some or all of the problems of the current state of the art, by proposing a flight system that equips a user and enables him to vary his posture during flight, is easy to access and offers increased maneuverability, leaving the user's limbs free.

### SUMMARY OF THE INVENTION

More precisely, the invention relates to a flight system comprising:
a harness configured to be worn by a user, said harness at least partially covering the torso and surrounding the user's hips;
a plurality of primary propulsion modules connected to the harness, the plurality of primary modules being distributed symmetrically at the level of the user's hips on either side of a sagittal plane of the user's body, the primary modules being configured to exert a primary thrust force so as to raise or maintain the user in the air;
at least one energy reservoir configured to supply energy to the plurality of primary propulsion modules.

The flight system is remarkable in that the plurality of primary propulsion modules is pivotable, via ball-and-socket connections between the harness and the plurality of primary propulsion modules, at least between a vertical flight configuration wherein a frontal plane of the user's body extends perpendicularly to the ground and a horizontal flight configuration wherein the frontal plane of the user's body extends parallel to the ground.

The term “sagittal plane” refers to an anatomical plane of the user's body, passing through the center of gravity of the user's body and symmetrically dividing the body into a right and a left part.

The term “frontal plane” refers to an anatomical plane of the user's body, passing through the center of gravity of the user's body, perpendicular to the sagittal plane and dividing the body into a front part and a rear part.

The term “transverse plane” refers to an anatomical plane of the user's body, passing through the center of gravity of the user's body, perpendicular to the sagittal plane and the frontal plane, and dividing the body into an upper and a lower part.

The term “torso” refers to the upper part of the user's body, which, unless otherwise specified, includes both the user's chest and back.

Thanks to such a combination of features, such a flight system enables an equipped user to fly in any flight configuration between the horizontal flight configuration and the vertical flight configuration, and to switch from one configuration to another during flight. In this way, the user can simply choose the most appropriate configuration, for example according to the phase of flight, stability conditions or topology of the environment overflown. For example, the user can perform a takeoff operation in a vertical flight configuration and then, on reaching a satisfactory altitude, make a transition from the vertical flight configuration to the horizontal flight configuration. This is true both for the configuration of horizontal flight on the belly and for the configuration of horizontal flight on the back. Similarly, the user can make a transition from the horizontal flight configuration to the vertical flight configuration, for example to perform a landing operation. What's more, such a flight system leaves the user's hands and legs free, simplifying flight. The user can then interact with his immediate environment, for example to perform manual tasks using tools, or to stand on structures without constantly worrying about his stability and balance in flight. Such a flight system is thus configured to guarantee the user's balance and stability in flight, whatever the flight configuration and whatever his proprioceptive ability and control of the flight system.

Advantageously, the primary thrust force is parallel to the frontal plane in the vertical flight configuration, and the primary thrust force is perpendicular to the frontal plane in the horizontal flight configuration. In such a configuration, the flight system allows the user to take off or land perpendicular to the ground in both vertical and horizontal flight configurations. Such a configuration also enables hovering.

Advantageously, the plurality of primary modules can be pivoted into a take-off configuration wherein the thrust force of each of the primary modules 6 is perpendicular to the sagittal plane and directed away from the user so that the primary thrust force is zero. In such a configuration, the user on the ground can adjust the primary thrust force without it being directed towards the ground, and switch from the take-off configuration to one of the flight configurations when the thrust is sufficient for the user to be able to ascend fully without risk.

Advantageously, the flight system comprises a plurality of secondary propulsion modules connected to the harness, the plurality of secondary propulsion modules being symmetrically distributed over the user's shoulders and configured to exert a secondary thrust force. In such a configuration, the thrust forces lifting the user are partially distributed over the user's upper body, providing greater stability, particularly in horizontal flight configuration.

Advantageously, the harness comprises knee pads configured to be worn by the user and a plurality of tertiary propulsion modules connected to the knee pads, the plurality of tertiary propulsion modules being symmetrically distributed at the user's knees and configured to exert a tertiary thrust force. In such a configuration, the thrust forces lifting the user are partially distributed over the user's lower body, providing greater stability, particularly in vertical flight configuration.

Advantageously, the energy reservoir is secured to the harness at the user's torso. In this configuration, users carry their own energy reserves. The reservoir is located on the user's back, for example.

Advantageously, the reservoir comprises a first compartment configured to supply propulsion modules on a first side of the sagittal plane and a second compartment configured to supply propulsion modules on a second side of the sagittal plane. In such a configuration, the position of reservoirs can be adapted to be as close as possible to the supplied modules. In addition, part of the user's back can be left free, for example to accommodate additional equipment.

According to one embodiment, the flight system comprises a back propulsion module connected to the harness at the user's torso and configured to exert a back thrust force. The back thrust force is parallel to the user's frontal plane. In the vertical flight configuration, the back thrust force contributes to the user's vertical movement. In the horizontal flight configuration, the back thrust force enables the user to move horizontally. In any intermediate configuration, the back thrust force contributes to both the vertical and horizontal movement of the user. Back thrust also helps to remain airborne, especially when hovering.

Advantageously, the primary propulsion modules on a given side of the sagittal plane are secured to at least one adjacent primary module, a single primary propulsion module being in ball-and-socket connection with the harness. In such a configuration, all the propulsion modules on a given side of the sagittal plane can be pivoted simultaneously using a single pivot link, simplifying the manufacture of the flight system.

Advantageously, each primary propulsion module on a given side of the sagittal plane is in ball-and-socket connection with the harness, the pivoting of a given primary propulsion module being independent of the pivoting of the other primary propulsion modules on the same side. In such a configuration, each primary propulsion module on a given side can exert a thrust force in a different direction, enabling further diversification of flight configurations.

Advantageously, the plurality of primary propulsion modules can be pivoted into an advance configuration wherein the primary thrust force forms a first advance angle relative to the ground. In such a configuration, a vertical component of the primary thrust force allows the user to be held aloft or lifted, that is, allows the user to move vertically, and a horizontal component of the primary thrust force allows the user to move horizontally.

Advantageously, the primary modules on a first side of the sagittal plane rotate synchronously and the primary modules on a second side of the sagittal plane rotate synchronously, with the rotations of the modules on the first side and the modules on the second side being independent. This enhances the user's ability to move around, for example to rotate or move horizontally in the frontal plane.

Advantageously, the primary propulsion modules on a given side of the sagittal plane are distributed symmetrically with respect to the frontal plane of the user's body. In such a configuration, the horizontal movement for a user is identical when the user moves forward of the frontal plane or when the user moves backward of the frontal plane.

### BRIEF DESCRIPTION OF THE FIGURES

The invention will be better understood upon reading the following description, given by way of example, and referring to the following figures, given as non-limiting examples, wherein identical references are given to similar objects, and wherein:

FIG. 1 is a schematic front isometric perspective representation of a user equipped with a flight system according to a first embodiment of the invention, in a vertical flight configuration;

FIG. 2 is a schematic rear isometric perspective representation of a user equipped with a flight system according to a second embodiment of the invention, in the vertical flight configuration;

FIG. 3 is a schematic front isometric perspective representation of a user equipped with a flight system according to a third embodiment in the vertical flight configuration;

FIG. 4 is a schematic front isometric perspective view of a user equipped with the flight system of FIG. 1 in a vertical flight configuration;

FIG. 5 is a schematic rear isometric perspective representation of a user equipped with the flight system of FIG. 1 in the horizontal flight configuration;

FIG. 6 is a schematic front isometric perspective view of a user equipped with the flight system of FIG. 1 in a take-off configuration;

FIG. 7 is a schematic front isometric perspective view of a user equipped with the flight system of FIG. 1 in a first forward configuration

FIG. 8 is a schematic rear isometric perspective representation of a user equipped with the flight system of FIG. 1 in another variation of the forward configuration.

FIG. 9 is a schematic front isometric perspective view of a user equipped with the flight system shown in FIG. 1, in a rotated configuration;

FIG. 10 is a schematic front isometric perspective view of a user equipped with the flight system shown in FIG. 1, in a turning configuration.

It should be noted that the figures set forth the invention in detail to implement the invention; although non-limiting, said figures of course being capable of being used to further define the invention where appropriate.

In the description and claims, the terms longitudinal, transverse and vertical will be adopted with reference to the X, Y, Z trihedron shown in the figures.

### DETAILED DESCRIPTION OF THE INVENTION

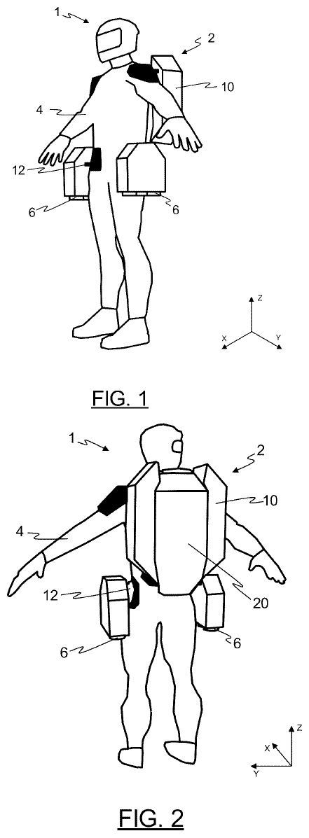

The invention concerns a flight system 2, in particular an individual “Jet Pack”-type flight system 2 fitted to a user 1, as shown in FIG. 1.

The user's body 1 has three anatomical planes intersecting at the user's center of gravity when not equipped with the flight system 2. A first anatomical plane, known as the “sagittal plane”, divides the user's body roughly symmetrically into right and left sides.

A second anatomical plane, known as the “frontal plane”, divides the body into a front part and a rear part. The frontal plane is perpendicular to the sagittal plane.

A third anatomical plane, known as the “transverse plane”, divides the body into an upper and a lower part. The transverse plane is perpendicular to the sagittal and frontal planes.

The flight system 2 includes a harness 4 configured to at least partially cover the torso and surround the hips of the user 1. The hip is understood here as the joint that forms the junction between the legs and the torso of the user 1. Here, harness 4 is a full-body suit, covering the body of the user 1. Alternatively, the harness 4 can comprise several independently equipped parts.

The harness 4 supports a plurality of primary propulsion modules 6. The primary propulsion modules 6 are configured to exert a primary thrust force to lift or hold the user 1 in the air. The primary modules 6 are symmetrically distributed at the user's 1 hips, on either side of the sagittal plane of the user's 1 body. In other words, a first part of the primary modules 6 is located on the left-hand side of the user's 1 body and a second part of the primary modules is located on the right-hand side of the user's 1 body. The primary modules 6 can optionally be housed in a single casing, as shown in FIG. 1, wherein each casing accommodates three primary modules 6. Naturally, the flight system 2 can comprise a total even number of primary modules other than six, for example two, four or eight modules.

Preferably, the primary modules 6 on the same side of the sagittal plane are distributed symmetrically with respect to the frontal plane of the user's 1 body. In such a configuration, the horizontal movement for the user 1 is identical when the user 1 moves forward of the frontal plane or when the user 1 moves backward of the frontal plane. In the remainder of this description, the term “forward movement” will be used to describe both the forward movement of the frontal plane and the rearward movement of the frontal plane.

Even more preferably, the primary propulsion modules 6 on a given side of the sagittal plane are secured to at least one adjacent primary module 6, a single primary propulsion module being in ball-and-socket connection 12 with the harness 4. In FIG. 1, the primary module 6 in the front plane is the module in ball-and-socket joint 12 with the harness 4. This primary module 6 is linked to two other primary modules 6, one in front of the front plane and the other behind the front plane. In such a configuration, all the primary propulsion modules 6 on a given side of the sagittal plane can be pivoted simultaneously using a single ball-and-socket joint 12, simplifying the manufacture of the flight system 2.

To generate thrust, the primary modules 6 are supplied with energy by at least one reservoir 10. Here, reservoir 10 is located on the torso of user 1 and is secured to the harness 4. The primary propulsion modules 6 can be powered by a liquid, solid or gaseous fuel stored in tank 10 in the case of thermal propulsion, such as kerosene, hydrogen or liquefied natural gas, but can also be powered by electrical energy, in which case tank 10 comprises at least one electric battery or an electric current generator system.

The plurality of primary modules 6 can be pivoted between the harness 4 and the plurality of primary modules 6 via ball-and-socket joints 12. In this way, the primary modules 6 enable the user to fly in a “vertical flight” configuration and a “horizontal flight” configuration. In the vertical flight configuration, the frontal plane of the user's body extends perpendicular to the ground, that is, perpendicular to a reference plane X, Y. In the horizontal flight configuration, the frontal plane of the user's body extends parallel to the ground, that is, parallel to the X, Y reference plane. The flight system 2 enables the equipped user 1 to fly in a horizontal and/or vertical flight configuration, and to switch from one configuration to another during flight. In this way, the user can choose the most appropriate configuration, for example depending on the phase of flight, stability conditions or the topology of the environment overflown. For example, the user 1 can perform a takeoff operation in vertical flight configuration and then, when he reaches a satisfactory altitude, transition from vertical to horizontal flight configuration. In the same way, the user 1 can make a transition from the horizontal flight configuration to the vertical flight configuration, for example to perform a landing operation. The flight system 2 can also enable the user 1 to fly in any flight configuration between the horizontal flight configuration and the vertical flight configuration. Such a flight system is thus configured to guarantee the user's balance and stability in flight, whatever the flight configuration and whatever his proprioceptive ability and control of the flight system.

To improve the comfort of the user 1, particularly in the horizontal flight configuration, the harness 4 can include retractable rods (not shown) that can be used to support the user's torso or legs.

In the embodiment shown in FIG. 1, the primary thrust force is parallel to the frontal plane in the vertical flight configuration, and the primary thrust force is perpendicular to the frontal plane in the horizontal flight configuration. In such a configuration, the flight system 2 authorizes the user 1 to take off or land perpendicular to the ground in both vertical and horizontal flight configurations. Such a configuration also enables hovering.

Note that “primary thrust force” means a force resulting from the thrust force of each individual primary propulsion module 6. So, as long as this resulting force is parallel to the frontal plane in vertical flight and perpendicular to the frontal plane in the horizontal flight configuration, the thrust force of a single primary propulsion module 6 can have a different orientation, compensated for by the orientation of the other primary propulsion modules 6.

FIG. 2 shows the flight system 2 in another embodiment of the invention. Here, the flight system 2 comprises a first reservoir 10 configured to supply propulsion modules on one side of the sagittal plane and a second reservoir 10 configured to supply propulsion modules on another side of the sagittal plane. In such a configuration, the position of the tanks 10 can be adapted to be as close as possible to the supplied modules. In addition, part of the user's back 1 can be left free, for example to simplify the reception of additional equipment. In FIG. 2, the flight system 2 includes a back propulsion module 20, connected to the harness 4, at the user's back. The dorsal propulsion module 20 is configured to exert a dorsal thrust force. The back thrust force is parallel to the frontal plane of the user 1. In the vertical flight configuration, the back thrust force contributes to the vertical movement of the user 1. In the horizontal flight configuration, the back thrust force enables the user 1 to move horizontally. It should be noted that the flight system 2 can include a dorsal propulsion module 20 even if it comprises a single fuel tank 10.

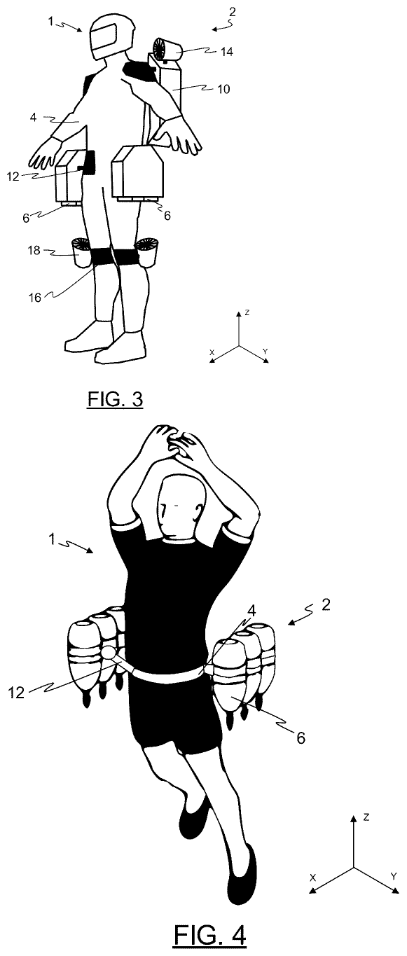

FIG. 3 shows the flight system 2 in another embodiment of the invention. Here, the flight system 2 notably comprises a plurality of secondary propulsion modules 14 connected to the harness 4, the plurality of secondary propulsion modules 14 being distributed symmetrically, above the shoulders of the user 1 and configured to exert a secondary thrust force. Here, the plurality of secondary modules 14 is pivotable via ball-and-socket connections 12 between the harness 4 and the plurality of secondary modules 14, at least between the vertical flight configuration, wherein the secondary thrust force is perpendicular to the frontal plane and the horizontal flight configuration, wherein the secondary thrust force is parallel to the frontal plane. In such a configuration, the thrust forces lifting the user 1 are partially distributed over the user's upper body, providing greater stability, particularly in the horizontal flight configuration.

On the flight system 2 shown in FIG. 3, the harness 4 comprises, independently of the secondary propulsion modules 14, knee pads 16 configured to be worn by the user 1. A plurality of tertiary modules 18 are connected to the knee pads, the plurality of tertiary propulsion modules 18 being symmetrically distributed at the user's knees 1 and configured to exert a tertiary thrust force. Here, the plurality of tertiary modules 18 is pivotable via ball-and-socket connections 12 between the knee pads and the plurality of tertiary modules 18, at least between the vertical flight configuration wherein the tertiary thrust force is perpendicular to the frontal plane and the horizontal flight configuration wherein the tertiary thrust force is parallel to the frontal plane.

Similarly to the primary thrust force, it should be noted that “secondary thrust force” means a force resulting from the thrust force of each individual secondary propulsion module 14. Thus, as long as this resulting force is parallel to the frontal plane in vertical flight and perpendicular to the frontal plane in the horizontal flight configuration, the thrust force of a propulsion secondary module 14 taken alone can have a different orientation, compensated for by the orientation of the other secondary modules 14. The same principle can be applied to the tertiary thrust force and tertiary modules 18.

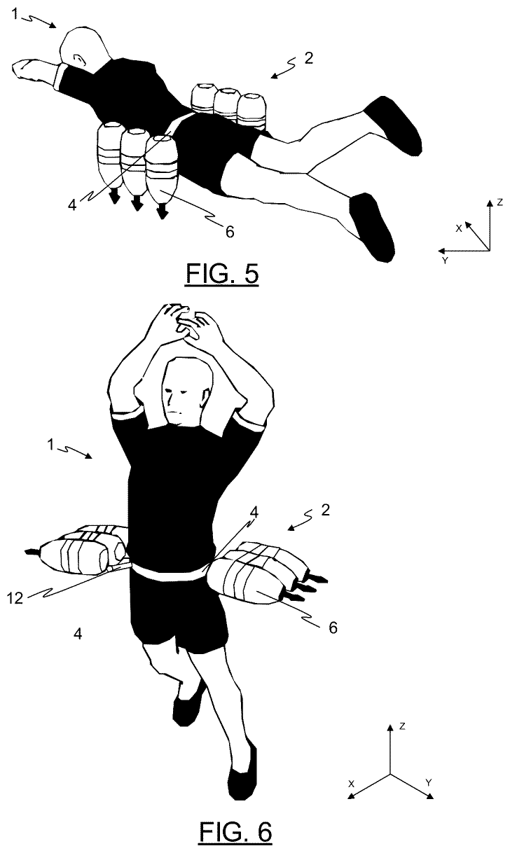

The remainder of this description describes the flight configurations of a user equipped with the flight system 2 according to the previously described embodiments, in particular the embodiment shown in FIG. 1. FIG. 4 shows a vertical flight configuration of the flight system described according to the first embodiment, and FIG. 5 shows the vertical flight configuration of the flight system described according to the first embodiment. For case of reading, only the user 1, the harness 4, the ball-and-socket connections 12 and the primary modules 6 are shown. It is understood that the flight system 2 as shown in FIG. 2 and FIG. 3 enables the movements described below.

FIG. 6 shows the flight system 2 in a take-off configuration, wherein the plurality of primary modules 6 are pivotable so that the thrust force of each of the primary modules 6 is perpendicular to the sagittal plane, facing away from the body of the user 1. In such a configuration, the user 1 on the ground can adjust the primary thrust force without the latter being directed towards the ground, and switch from the take-off configuration to one of the flight configurations when the thrust is sufficient for the user 1 to be able to rise fully without risk. Here, the user is shown standing on his feet at takeoff, but can alternatively be on his torso at takeoff, with the primary modules 6 pivoting identically in both cases.

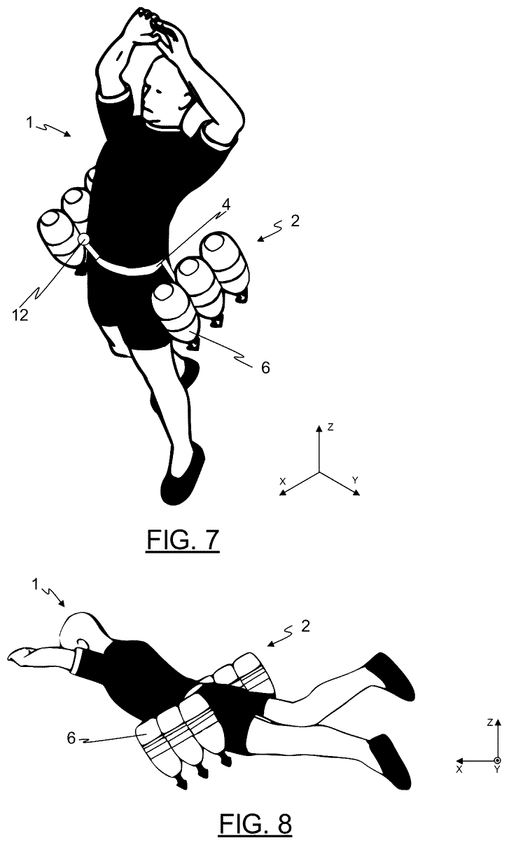

FIG. 7 and FIG. 8 show a user equipped with the flight system in a forward configuration according to two variants. The variant shown in FIG. 8 differs from FIG. 7 only in that in FIG. 8, the frontal plane of the user's 1 body is parallel to the ground. The plurality of primary propulsion modules can be pivoted into an advance configuration wherein the primary thrust force forms a first advance angle with respect to the ground. Such an angle means that the primary thrust force has both a vertical and a horizontal component. The vertical component of the thrust force enables the user to move vertically, in other words, this component counteracts the user's 1 weight and enables the user to be held aloft or to rise. The horizontal component allows the user 1 to move forward.

To enhance the range of possible movements, the primary modules 6 on a first side of the sagittal plane can be rotated synchronously, and the primary modules 6 can be rotated synchronously, with the rotations of the modules on the first side and the modules on the second side being independent. In other words, the primary modules 6 on the first side of the sagittal plane and on the second side of the sagittal plane can be at different angles to the user's 1 body. The value of the thrust force exerted by the primary modules 6 on the first side of the sagittal plane can also be different from the value of the thrust force exerted by the primary modules 6 on the second side of the sagittal plane, further enriching movement possibilities.

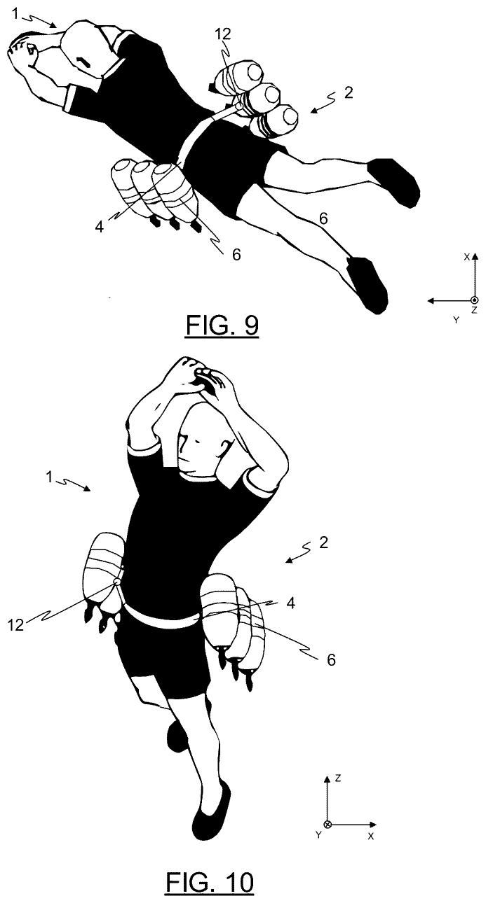

The user 1 can, for example, turn on himself by rotating along the transverse axis Y, as shown in FIG. 9, by rotating the primary modules along the same transverse axis Y. Rotation along the vertical axis Z is also possible, by rotating the primary modules 6 along the vertical axis Z. The user 1 can also move horizontally in the frontal plane, here by rotating only the primary modules on a given side of the sagittal plane around the longitudinal axis X, as shown in FIG. 10. In the horizontal flight configuration, the primary modules 6 on either side of the sagittal plane can be pivoted around the longitudinal axis X to improve horizontal movement.

As a reminder, the movements described and shown in FIG. 4, FIG. 5, FIG. 6, FIG. 7, FIG. 8, FIG. 9 and FIG. 10 are compatible with a flight system 2 as shown in FIG. 2 and FIG. 3. The pivoting of the secondary modules 14 and tertiary modules 18 is then adapted to perform the movements described.

The flight system advantageously comprises a control device (not shown). The control device is configured to enable the user to control his movements from the flight system, as well as transitions from one configuration to another. In particular, to determine the angle of advance of the thrust force relative to the ground, the control device can comprise a plurality of sensors configured to detect an instruction formed by the user's hands, each instruction corresponding to a given hand sign. For example, a closed fist, palm down, may correspond to an advance instruction. In this way, the user can control a horizontal movement, a vertical movement or a combination of these two movements as described above. Alternatively or additionally, instructions can be given by moving the user's head, enabling more instructions. In particular, to determine the configuration of the user's body relative to the ground, the control unit can comprise a plurality of sensors configured to detect an instruction formed by a movement of the user's torso. For example, a backward movement of the shoulders can correspond to a pivoting instruction so that the user's body switches from the horizontal flight configuration to the vertical flight configuration. Finally, to determine the thrust force value of the propulsion modules in particular, the control unit can include a remote control enabling the user to select from a set of predetermined force values. Each predetermined value can, for example, correspond to an intuitive “level” for the user. In particular, the remote control can take the form of a denture worn by the user in his or her mouth, with the user actuating a level by squeezing the denture with his jaw. Alternatively, the remote control can, for example, take the form of a handle fitted with a joystick and/or buttons and/or triggers, or a touch screen mounted on one of the user's arms.

It should also be noted that the invention is not limited to the embodiments described above. Indeed, it will become apparent to the person skilled in the art that various modifications can be made to the above-described embodiment, in the light of the teachings just disclosed.

In the detailed presentation of the invention given above, the terms used should not be interpreted as limiting the invention to the embodiment set out in the present description, but should be construed to include all equivalents the anticipation of which is within the abilities of a person skilled in the art by applying his general knowledge to the implementation of the teaching just disclosed to them.

1. A flight system comprising:
a harness configured to be worn by a user, said harness at least partially covering the torso and surrounding the hips of the user;
a plurality of primary propulsion modules connected to the harness, the plurality of primary modules being symmetrically distributed at the user's hips on either side of a sagittal plane of the body of the user, the primary modules being configured to exert a primary thrust force so as to raise or maintain the user in the air;
at least one energy reservoir configured to supply energy to the plurality of primary propulsion modules;
wherein the plurality of primary propulsion modules is pivotable, via ball-and-socket connections between the harness and the plurality of primary propulsion modules, at least between a vertical flight configuration wherein a frontal plane of the body of the user extends perpendicularly to the ground and a horizontal flight configuration wherein the frontal plane of the body of the user extends parallel to the ground.

2. The flight system according to claim 1, wherein the primary thrust force is parallel to the frontal plane in the vertical flight configuration and the primary thrust force is perpendicular to the frontal plane in the horizontal flight configuration.

3. The flight system according to claim 1, wherein the plurality of primary modules is pivotable into a take-off configuration wherein the thrust force of each of the primary modules is perpendicular to the sagittal plane and directed away from the user so that the primary thrust force is zero.

4. The flight system according to claim 1, comprising a plurality of secondary propulsion modules connected to the harness, the plurality of secondary propulsion modules being symmetrically distributed over the shoulders of the user and configured to exert a secondary thrust force.

5. The flight system according to claim 1, wherein the harness comprises knee pads configured to be worn by the user and a plurality of tertiary propulsion modules connected to the knee pads, the plurality of tertiary propulsion modules being symmetrically distributed at the knees of the user and configured to exert a tertiary thrust force.

6. The flight system according to claim 1, wherein the energy reservoir is secured to the harness at the level of the user's torso.

7. The flight system according to claim 6, wherein the tank comprises a first compartment configured to supply propulsion modules on a first side of the sagittal plane and a second compartment configured to supply propulsion modules on a second side of the sagittal plane.

8. The flight system according to claim 1, comprising a dorsal propulsion module (20) connected to the harness at the torso of the user and configured to exert a dorsal thrust force.

9. The flight system according to claim 1, wherein the primary propulsion modules on a given side of the sagittal plane are secured to at least one adjacent primary module, a single primary propulsion module being in ball-and-socket connection with the harness.

10. The flight system according to claim 1, wherein the plurality of primary propulsion modules is pivotable into a forward configuration wherein the primary thrust force forms a first forward angle with respect to the ground.

11. The flight system according to claim 1, wherein the primary modules on a first side of the sagittal plane pivot synchronously and the primary modules on a second side of the sagittal plane pivot synchronously, the pivoting of the modules on the first side and the modules on the second side being independent.

12. The flight system according to claim 1, wherein the primary propulsion modules on a given side of the sagittal plane are distributed symmetrically with respect to the frontal plane of the body of the user.
